(19) United States
(12) Patent Application Publication
(10) Pub. No.: US 2026/0180974 A1
(43) Pub. Date: Jun. 25, 2026

(54) A SYSTEM AND METHOD TO PROVIDE A PRIVACY-PRESERVING HARDWARE SECURE ENCLAVE ENVIRONMENT FOR GENERATING BLOCKCHAIN VERIFIABLE TRANSACTIONS AT SCALE

(71) Applicant: APPLIED BLOCKCHAIN LTD., London (GB)

(72) Inventor: Adi BEN ARI, London (GB)

(21) Appl. No.: 19/485,390

(22) PCT Filed: May 16, 2024
(86) PCT No.: PCT/IL2024/050475

§ 371 Date: Nov. 18, 2025

Related U.S. Application Data
(60) Provisional application No. 63/467,438, filed on May 18, 2023.

(51) Int. Cl. H04L 9/40; H04L 9/06; H04L 9/08; H04L 9/14; H04L 9/32

(52) U.S. Cl. CPC H04L 63/0823; H04L 9/0637; H04L 9/0643; H04L 9/0825; H04L 9/14; H04L 9/3236; H04L 9/3239; H04L 9/3247; H04L 9/3263; H04L 9/3265

(57) ABSTRACT

A method and system for providing programmable data privacy on one blockchain that leverages security properties from another, more decentralised, blockchain. The system comprises scalable zero knowledge rollup components such as a blockchain Node, Prover, and Sequencer, hosted in a Trusted Execution Environment (TEE), such that blockchain data is not revealed to the host, and data access can be managed programmatically. The system includes a service in the TEE for gatekeeping access to the data hosted blockchain and zero knowledge rollup components, enabling a programmable privacy-preserving environment for blockchains using smart contracts and isolates hosting operators from access to sensitive user accounts, data, transactions and balances.

### BACKGROUND

### The Blockchain Trilemma:

Blockchains should have the following properties: Scalability, Security and Decentralization. The three properties are interdependent, each one affecting the other two. This interdependency has an intrinsic drawback in that maximizing two out of the three properties negatively affect the third. This has been described as the Blockchain Trilemma (FIG. 1).

### Scalability

In order to relieve network congestion, cost of transaction and speed of transaction. scalability is important. Solutions have been proposed such as increased block size, removal of redundant information and segregated witness (splitting transactions into two segments, removing the unlocking signature (“witness” data) from the original portion and appending it as a separate structure at the end).

### Decentralization:

Decentralization is a property regarding the fragmentation of control over the protocol and redundancy around access to data. In the Bitcoin and Ethereum protocols, users submit transactions for node operators to sequence into blocks. Better decentralization of node operators means higher resistance against change to previous transactions, balances and state. This allows the chain to run without any trust dependencies on a single actor.

### Security:

Blockchain security implies mitigation of overall security risk of the system. There are several ways of breaching blockchain security including the following:
Routing attacks—Hackers intercept the data on its way to node operators.
51% attacks—A group of unethical node operators seizes control over a ledger by acquiring more than 50% of a blockchain network's voting power.

For a chain to be considered relatively secure it must be able to resist a large proportion of participating nodes trying to attack it.

The following classes of “easy solutions” fail the Blockchain Trilemma test in that they only provide two properties out of Scalability, Decentralization and Security.
Traditional blockchains—including Bitcoin, pre-PoS/sharding Ethereum, Litecoin, and other similar chains. These rely on every participant running a full node that verifies every transaction, and so they have decentralization and security, but not scalability.
High-TPS chains—including the DPoS family but also many others. These rely on a small number of nodes (often 10-100) maintaining consensus among themselves, with users having to trust a majority of these nodes. This is scalable and secure (using the definitions above), but it is not decentralized.
Multi-chain ecosystems—this refers to the general concept of “scaling out” by having different applications live on different chains and using cross-chain-communication protocols to talk between them. This is decentralized and scalable, but it is not secure, because an attacker need only seize voting control over one of the many chains (so often <1% of the whole ecosystem) to break that chain and possibly cause ripple effects that cause great damage to applications in other chains.

One solution to the Trilemma is providing ZK (Zero Knowledge) rollups.

A zero-knowledge rollup (zk-rollup) is a layer-2 (and beyond) scaling solution that moves computation and state off the main chain (layer-1, e.g. Ethereum), into secondary chain components or networks (layer-2, and beyond), while storing cryptographic proof of valid transactions and state updates (“Validity Proofs”) on-chain on a layer-1 network.

The ZK Rollups create succinct zero knowledge Validity Proofs as cryptographically verifiable proof of the integrity of a large, ordered, batch of transactions collected in layer-2 i.e. outside the layer-1 blockchain. The Validity Proofs are posted to a layer-1 blockchain smart contract where they are verified.

### Data Privacy:

A blockchain is a distributed database, and data is therefore shared across a number of participants. Standard blockchain consensus secures historical data against change, but the data can be viewed by Node operators, and in many public blockchains, the data can be viewed by anyone. In order for a blockchain to be used in a commercial and data sensitive setting, information such as accounts, transactions, amounts as well as other data might need to be hidden from blockchain node operators and the general public. We refer to this as “programmable” data privacy, such that business logic can dictate which items of the blockchain data are made available only to specific users, depending on the business logic rules programmed into a smart contract.

A number of solutions to blockchain data privacy exist:
Private blockchains. These involve running an isolated set of blockchain nodes in a closed network of participants. Private blockchains lack decentralization (see blockchain trilemma). They also require every party that requires data privacy from the other parties to become a Node operator, significantly increasing cost and friction.
Zero-knowledge (ZK) privacy schemes are applied to layer-1 blockchains such as zCash. These use zero knowledge cryptography to hide accounts, transactions and amounts from node operators and users, while enabling those to validate the integrity of the ledger.
Trusted execution environments (TEE's) can be used to host layer-1 blockchain nodes, and therefore hide accounts, transactions and amounts from node operators and users.

### Solving the Trilemma and Data Privacy

ZK rollups solve the blockchain trilemma by enabling scalability while maintaining security and trust through extensive decentralization. However, there is a lack of data privacy in a ZK rollup system because in a typical ZK rollup system all of the data is public and visible to all of the participants. There is therefore a need to provide a solution that solves the blockchain trilemma, by providing security, scalability and decentralization, while also enabling selective data privacy. Utilizing hardware secure enclaves or TEEs (Trusted Execution Environments) for certain aspects of the user blockchain interaction allows selective privacy, because a TEE is able to hide data from the system operators and general public, while enabling data access to specified users. Data stored by the TEE on system operator's machine is always encrypted by the TEE first. If a user needs to see their own data, or a regulator needs to see hidden data, they will be able to access and decrypt data that has been programmatically shared with them. For example, a business may wish to hide details of transactions with suppliers and customers, such as volume and price, while ensuring that certain attributes of supply chain provenance are verifiable and/or visible. Where a regulator has the right to inspect certain data, the system must already contain programmatic authorisation for their access, if they are to access the data in practice. This type of role-based access to on-chain data is enabled by this solution, while solving the blockchain trilemma.

Note that in the context of blockchains, transactions are often instructions to transfer amounts from one account to another, however instructional payloads for performing state transitions on smart contracts are also considered transactions. Instructions to deploy smart contracts are also transactions.

### SUMMARY OF THE INVENTION

It is an objective of the present invention to provide a method of isolating operators from access to selected user data and transactions on a blockchain, while solving the blockchain trilemma, by hosting ZK rollups 100 in a Trusted Execution Environment TEE 300, comprising steps of hosting, the blockchain Node 315, the Prover 330, and the sequencer 320 in a TEE, encrypting and processing data sent to the blockchain Node 315, Sequencer 320 component and Prover 330 component in a privacy-preserving environment.

It is an objective of the present invention that transactions are processed by a ZK rollup components in a TEE and Validity Proofs are posted and validated by an External blockchain (e.g. main network, layer-1). An External blockchain is any blockchain that has stronger trust assumptions (e.g. decentralization), and could be private or public (e.g. Ethereum layer-1).

It is a further object of the present invention to provide the aforementioned method wherein said TEE is a Hardware Secure Enclave 211.

It is a further object of the present invention to provide the aforementioned method wherein the steps of hosting the ZK rollup components are in a plurality of TEEs, with transport layer security between components. Furthermore we extend the transport layer security protocol to include mutual attestations that the communications come from TEEs. Common transport layer protocols include but are not limited to TLS, DTLS, and QUIC. Attestations typically include a fingerprint of the running code, and a digital signature by the TEE on the fingerprint and the SSL public key, all validated by the counterparty.

It is a further object of the present invention to provide the aforementioned method wherein said TEEs may have multiple cores on one server or multiple cores split across multiple servers or virtual machines, communicating over an encrypted and attested network.

It is a further object of the present invention to provide the aforementioned method comprising steps including enabling blockchain wallet 111 holders to send transactions to ZK rollup components hosted inside a TEE 300, and retrieve their account information including information on their assets, transactions, smart contracts and data within smart contracts they are permissioned to access

It is a further object of the present invention to provide the aforementioned method wherein said sent data comprises transactions, block, smart contract and network statistics.

It is a further object of the present invention to provide the aforementioned method wherein the system may be configured so that only the Sender and Receiver is able to access the origin and destination of a transaction, amount or payload of the transaction, the transaction unit, contract address and input data.

It is a further objective of the present invention to provide the aforementioned method comprising initiation steps of providing TEE's and their application, blockchain Node, Sequencer, Prover with the required source code and libraries requesting processor manufacturer attestation and storing each attestation in order to baseline each TEE providing means for users to inspect and verify each attestation independently.

It is a further object of the present invention to provide the aforementioned method comprising registering TEE's with said components in blockchain smart contracts using a cryptographic signature chain such that any change to the TEE trust base could be detected by the Registry smart contracts in the External blockchain.

It is a further object of the present invention to provide the aforementioned method comprising steps of TEE's symmetrically exchanging 700 secret recovery key 112s to create redundancy across multiple TEE's, for mitigating damage in case a TEE processor 210 should fail, or be declared not secure by the manufacturer.

It is a further object of the present invention to provide the aforementioned method comprising steps of all blockchain Node TEE's performing a transport layer handshake with an attestation extension to create redundancy across multiple blockchain Node TEEs.

It is a further object of the present invention to provide the aforementioned method comprising steps of al Sequencer TEE s performing a transport layer handshake with an attestation extension to create redundancy across multiple Sequencer TEE s.

It is a further object of the present invention to provide the aforementioned method comprising steps of al Prover TEEs performing a transport layer handshake with an attestation extension to create redundancy across multiple Prover TEEs.

It is a further object of the present invention to provide the aforementioned method comprising steps of all, or any combination of, whether hosted in the same TEE or multiple TEE's, that Application, blockchain Node, Sequencer, and Prover TEE's exchanging public and/or symmetric keys to create trusted, private communication across all TEE's in the TEE network of ZK Rollup components with redundancy (TEE Mesh). A TEE Mesh is defined as the network of trusted execution environments which may communicate with each other over encrypted, authenticated and attested channels.

It is a further object of the present invention to provide the aforementioned method comprising steps of creating at least one “Registry” smart contract 500 on the External blockchain, listing the public keys and hashes of each TEE in the system.

It is a further object of the present invention to provide the aforementioned method A method of carrying out secure blockchain transactions comprising steps of user signing the transaction with the device wallet using the sender's private key and encrypting the communication with TLS or some other transport layer protocol and sending encrypted transaction 800 to the blockchain Node.

It is a further object of the present invention to provide the aforementioned method comprising steps of blockchain Node sending the transaction to a Sequencer placing the transaction in the correct order relative to other transactions, without leaving the boundaries of a TEE Mesh.

It is a further object of the present invention to provide the aforementioned method comprising steps of sending transactions to a first Sequencer in a decentralized network of Sequencers, said first Sequencer receiving transactions from other Sequencers and optionally proposing a block, and interacting with the other Sequencers in the decentralized network to reach consensus, without leaving the boundaries of a TEE Mesh.

It is a further object of the present invention to provide the aforementioned method comprising steps of user carrying out secure blockchain transactions using an application via a browser 113 on the user device, or running the application on a backend server inside an organization's secure network boundaries (e.g. internal network, VPN), the transaction created by a Browser 113 Application, Mobile Application, or an Internal Application.

It is a further object of the present invention to provide Data Availability to each user by encrypting each transaction and state in the Sequencer involving a user in the ordered list including transaction information, using the public keys of the transaction owner(s) and smart contract participants, for future decryption, distributing the User-encrypted transactions and state in one or more data stores 220 directly accessible to users, enabling users to retrieve their transactions and/or state required for account and balance proof verification and recovery using the External blockchain smart contracts, independently of (layer-2, and beyond) the ZK rollup components and operators.

It is a further object of the present invention to provide the aforementioned method comprising steps of the blockchain Node and Sequencer encrypting their state TEE key to provide a sealed status 325 and storing the sealed state in one or more data stores to enable recovery by the same or another TEE in the TEE Mesh.

It is a further object of the present invention to provide the aforementioned method comprising steps of the blockchain Node sending transactions to the Sequencer, creating and sharing the ordered list of transactions, optionally forming a “block” or “batch” and sending these to a Prover within the TEE Mesh such that transactions, accounts, addresses, smart contract state, blockchain logs and other data are not revealed outside of the TEE Mesh.

It is a further object of the present invention to provide the aforementioned method comprising steps of the Prover TEE generating a Validity Proof 335, and the Prover, or aggregator or Sequencer component outputting the Validity Proof from the TEE and sending the Validity Proof to an External blockchain for a step of verification in a smart contract.

It is a further object of the present invention to provide the aforementioned method comprising steps of sending a succinct Validity Proof to the External blockchain.

It is a further object of the present invention to provide the aforementioned method comprising steps of sending the Validity Proof signed by a TEE in the TEE Mesh providing proof of the source code used for generating the TEE as a proof that the signing was executed in a privacy-preserving TEE environment (i.e. the TEE Mesh).

It is a further object of the present invention that each TEE which communicates with another TEE sends a signed and unforgeable fingerprint of the code running. Each TEE checks the fingerprint against a whitelist to ensure that it is communicating with an allowed TEE within the TEE mesh.

The transaction batch hash is constructed from a merkle tree of the transactions included. This batch hash is then signed by the TEE-mesh, typically by the sequencer.

The External Blockchain receives the signed hash of the transaction batch from the Sequencer, and validates that the signature came from the Sequencer inside the TEE. A succinct proof is generated by the TEE-mesh, typically by the Prover and Aggregator services. This ‘proof’ proves that the Prover has knowledge of a list of valid transactions which produce a merkle tree with the expected batch hash. Since the prover need only demonstrate that such a batch exists not that they are aware of the transactions inside it, proving they know of a proof which they can verify will also suffice and allows for further scaling.

The External Blockchain then validates that batch proof received from the Aggregator corresponds to this hash, and verifies the succinct batch proof.

It is a further object of the present invention to provide a method comprising steps of constructing a Merkle tree of the ZK rollup with each update to a leaf hash above the Merkle tree root, each update accompanied by a TEE Mesh signature proving to a user seeing an updated Merkle root, but not having access to the data behind the Merkle tree hash updates, that the updated hashes were generated correctly in a prover TEE running the expected logic code.

It is a further object of the present invention to provide the aforementioned method comprising steps of the TEE revealing proof of knowledge of the Merkle tree of the ZK rollup to all users, outputting from the TEE proving that each of the hashes in the Merkel tree was generated correctly such that a user can trust that a new Merkle tree is valid, while underlying transactions and state for transactions that were not shared with them are unseen and inaccessible by the user. The External Blockchain smart contract then validates that the proof is valid, accepting the state update. Users may make emergency transactions based on the latest state update proof, to exit and recover funds on the External Blockchain. It is a further object of the present invention to provide a system for providing utilities for an External B lockchain comprising ZK rollup components including wallets, a blockchain explorer, Application server, blockchain Node, Prover, and sequencer hosted in a Trusted Execution Environment and means for encrypting and processing data sent to the hosted blockchain Node, Sequencer component and Prover component in the TEE.

It is a further object of the present invention to provide the aforementioned system wherein said TEE is a Hardware Secure Enclave 211 with manufacturer attestation of code running inside the Hardware Secure Enclave.

It is a further object of the present invention to provide the aforementioned system wherein the hosting of the ZK rollup components may be in one TEE or across a plurality of TEEs.

It is a further object of the present invention to provide the aforementioned system wherein said TEEs may have multiple cores on one server or split across multiple servers or a combination of virtual machines.

It is a further object of the present invention to provide the aforementioned system comprising means for enabling blockchain wallet holders to send transactions to ZK rollup components hosted inside a TEE, and retrieve their account information including information on their assets, transactions and smart contracts, where this is permitted by rules defined in smart contracts.

It is a further object of the present invention to provide the aforementioned system wherein data sent by users comprises transactions, blocks, smart contracts and network statistics.

It is a further object of the present invention to provide the aforementioned system configured so that only the Sender and Receiver and any other party defined in smart contract code is able to access the origin and destination of a transaction, amount of the transaction, the transaction unit, contract address and input data.

It is a further object of the present invention to be able to attest a workload at runtime on a TEE which does not directly support workload attestation at runtime. This is enabled by having a TEE which does support workload attestation at runtime verify that it is communicating with a valid TEE which does not support workload attestation at runtime before deploying a workload into that enclave and attesting this deployment at runtime, and the attested TEE ensuring that no other code is deployed into the non-attested TEE.

### BRIEF DESCRIPTION OF THE FIGURES

FIG. 1 depicts the “Blockchain Trilemma”.

FIG. 2 is a schematic depiction of the TEE ZK Rollup architecture.

FIG. 3 is a schematic depiction of TEE Code Version and Upgrade Management.

FIG. 4 is a schematic depiction of a Scheme for Managing Multiple TEE instances of blockchain node, Sequencer and Prover in a TEE Mesh.

FIG. 5 is a schematic depiction of a mechanism for obtaining runtime code attestation guarantees from a mesh of TEEs where only some support runtime code attestation

### DESCRIPTION OF THE PRESENT INVENTION

The present invention describes a system and method for providing a privacy-preserving TEE mesh for generating Blockchain verifiable transactions at scale. The purpose of the present invention is to enable preservation of selective privacy while solving the blockchain trilemma in Blockchains throughout the end-to-end process of use.

### DETAILED DESCRIPTION OF THE FIGURES

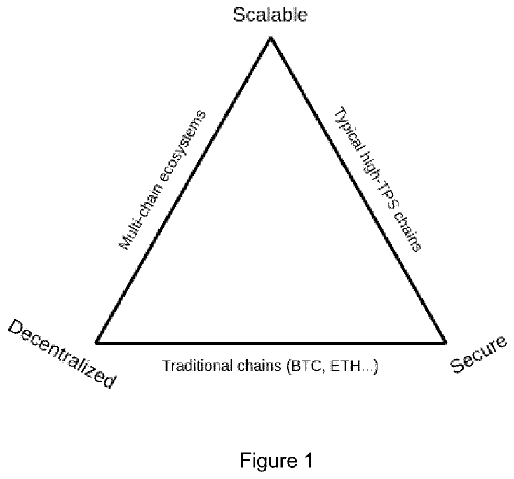

FIG. 1 is a schematic depiction of the Blockchain Trilemma, namely that Public Blockchains can generally fulfil only 2 out of the following properties: Scalability, Security and Decentralization.

The following figures explain the major aspects of the present invention.

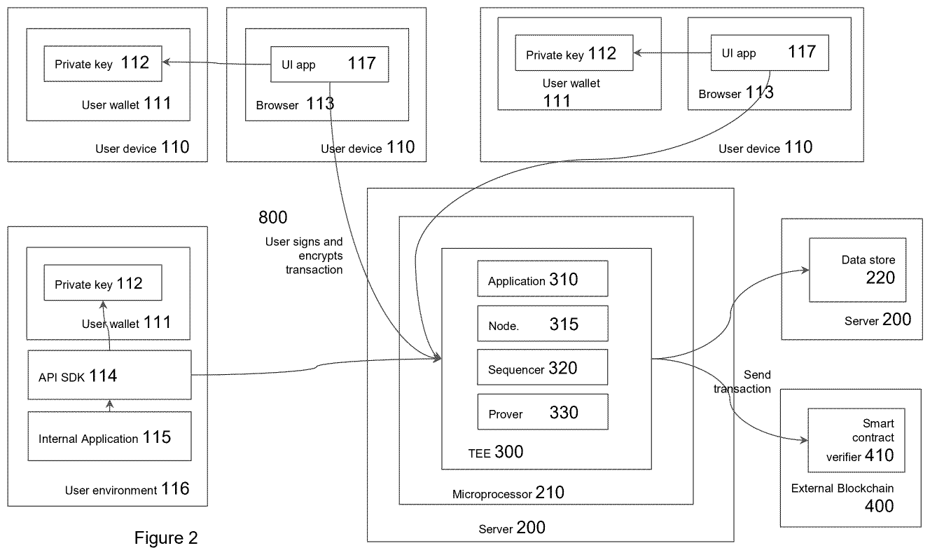

FIG. 2 is a schematic depiction of the Wallet Interaction with ZK Rollup in TEE scheme. The user signs the transaction (sent encrypted over TLS).

An application that uses a ZK rollup is typically comprised of a number of components including a User Wallet 111 hosting a Private Key 112, a “client side” application (this could be a UI App 117 in a Browser 113, or a mobile app, or a server based app 115) including a blockchain explorer, and an optional “server side” application 310.

A ZK rollup is typically comprised of a number of components including a blockchain Node 315, Sequencer 320 and a Prover 330.

Users have a number of ways to interact with blockchain applications hosted in the TEE ZK Rollup, and the browser 113 is where the user sees and interacts with the web application (117). Users can interact through a browser, a mobile phone (browser or mobile application) or laptop or desktop or a company through their own systems integration server. The wallet 111 holds the private key 112 on a device such as a keyring. The browser may be on a separate device 110 such as a mobile phone or laptop. In other embodiments of the invention the private key and the browser may be on the same laptop or desktop device 110, or the private key may be created as a passkey shared by a multi-device operating system and backed up encrypted in the cloud. In all of the cases, the private key is used to produce an encrypted digital signature that signs a transaction, which is sent to the ZK Rollup blockchain Node that is hosted inside a TEE.

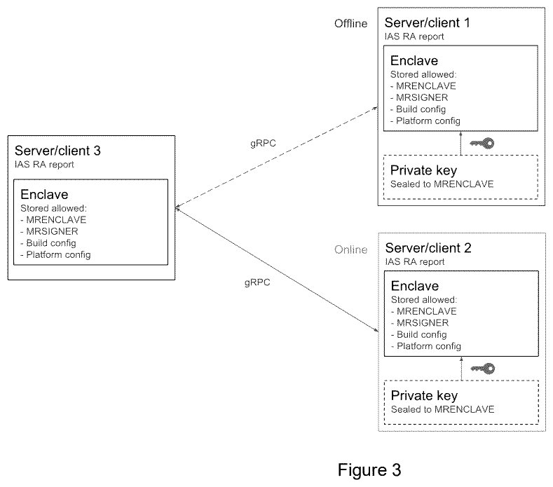

FIG. 3 is a schematic depiction of the TEE ZK Rollup application architecture. The signed transaction is sent encrypted via TLS to the ZK Rollup sequencer 212 which is located in a TEE 211 on the Server 200.

The Sequencer 320, a component of the ZK rollup, sets the order of transactions, and this important information is kept hidden from the operator within the TEE 300, so that the operator cannot cheat by, for example, exploiting the details of customer orders and then bidding up the price of goods or services on offer (“front running”). Note that since the Sequencer operates inside a TEE, it cannot produce incorrect or malicious batches and so the product maintains its functional integrity when operating with a mock prover also inside a TEE.

The main innovation of the present invention is that the ZK rollup components, including the blockchain Node, Sequencer and Prover can be run in a TEE “mesh” such that sensitive data remains private, yet cryptographic proof is available to users of the system in order to verify integrity of the system.

The innovation here is that ZK Rollup is made private by running its components inside a TEE “mesh”, and adding a security layer, so that it can be run efficiently by an operator without that party being able to manipulate the data illegitimately or be party to user's confidential information.

This is achieved in the following way: The blockchain Node receives and process signed transactions from an external wallet and send these to the sequencer 320 for ordering, batching and sending to the Prover 330 for generation of cryptographic zero knowledge Validity Proofs of integrity of the transactions (the ZK rollup). The prover takes the batched transactions and generates a cryptographical proof (the Validity Proof), proving knowledge of a valid batch of transactions for the Sequencer-generated batch hash, from which it can be demonstrated that double-spending and use of non-existent assets did not occur.

The succinct Validity Proof is posted on the External Blockchain 400, as proof that the transactions are valid, without posting details of the transactions themselves T his is also known as a Validium Proof. This allows scaling up of the system, by reducing the data and transaction burden onto the External Blockchain, because only the Validity Proofs of the transactions are posted to the External Blockchain, and not the individual transactions or their data. The ZK Rollups allow transactions to be executed outside the External Blockchain, while only the Proofs are posted to the External Blockchain. If a user has a query about the validity of a transaction in the future, they can independently validate the proof on the External Blockchain and prove that a transaction is within the Merkle tree of the proof.

The Blockchain 400 (External Blockchain, Layer 1) Smart Contract Verifier 410 checks the transactions Validity Proof before it accepting it.

The blockchain Node, Sequencer and the Prover run in a TEE “mesh” where each component validates via attestation that it is speaking to another valid component so that no-one, not even the host, can see the data. After processing in the TEE “mesh” 300, the ZK Rollup transaction data (transactions and state) is stored in one or more separate private data availability stores 220 such that the data availability stores hold encrypted (sealed) persisted states of the TEE. The encryption is not individual TEE processor specific, such that if one TEE fails, a key sharing scheme between TEE's enables another TEE in the scheme (“mesh”) to recover the encrypted state data. The ZK Rollup transaction and state data is also made available directly to the user sending the transactions (and any other users with whom the user configures to share the data) to retrieve from the TEE Mesh. The user is also provided the state data required to recover their assets in the External Blockchain, should the ZK Rollup Mesh no longer be available.

The system has built-in scalability such that when a Validity Proof is sent, and sealed data is stored, and the stored data can be distributed among several servers hosting Data Stores.

It should be noted that the TEEs are designed such that the manufacturer allows the user to submit code into the enclave. The enclave itself will generate a ‘digital fingerprint’ of the code. The manufacturer's key will be used to fingerprint the user's code that was placed in the enclave. The code generates a manufacturer-specific attestation signature on the SSL public key and the fingerprint, proving that the fingerprint is authentic, and authenticating all further encrypted communications. The smart contract Registry receiving these manufacturer's MACs can verify and trust the attestation from the manufacturer so the user or TEE can be confident of the signatures authenticity, and therefore the authenticity, secure base, and code running inside the TEE.

In the present invention, the TEE Hardware Secure Enclave 211 can use a CPU, GPU or any combination thereof.

While both CPU and GPU TEEs focus on security and isolation, they differ in architecture. purpose, and workload. CPU TEEs are versatile and handle general-purpose tasks, whereas GPU TEEs excel in parallel workloads, especially in the context of AI, ML and ZKP.
CPU TEE:
   Primarily designed for general-purpose computation.
   Provides secure execution environments within the central processing unit (CPU).
   Used for a wide range of tasks, including running applications, managing system processes, and handling I/O operations.
GPU TEE:
   Specifically tailored for accelerating parallel workloads, such as graphics rendering, machine learning, and scientific simulations.
   Focuses on secure execution of GPU kernels (parallel code segments) while maintaining isolation from other GPU code and system components.

### 2. Architecture:

CPU TEE:
   Typically implemented using hardware features like Intel Software Guard Extensions (SGX) or ARM TrustZone.
   Provides memory encryption and enclaves for secure execution.
   Manufacturer may provide an attestation service (e.g. Intel Attestation Service) whereby TEE hardware and firmware can be attested as secure, and specific user code can be proven to be running in the TEE.
GPU TEE:
   Utilizes similar principles but is specific to GPUs.
   Often leverages virtualization techniques to create isolated GPU contexts for confidential workloads.

### 3. Workload:

CPU TEE:
   Executes general-purpose code, including operating system tasks, user applications, and system services.
   Suitable for a wide variety of workloads.
GPU TEE:
   Optimized for parallel workloads, such as deep learning training, image processing, and scientific simulations.
   Typically used in scenarios where massive parallelism is beneficial.

### 4. Parallelism:

CPU TEE:
   Supports limited parallelism (e.g., multiple threads).
   Not as efficient for massively parallel tasks.
GPU TEE:
   Designed for massive parallelism.
   Hundreds or thousands of cores execute tasks concurrently.
   Not as efficient for highly sequential tasks
   Not as efficient for tasks with high working memory requirements

### 5. Memory Hierarchy:

CPU TEE:
   CPU caches and memory hierarchy are critical for performance.
GPU TEE:
   GPUs have their own memory hierarchy (registers, shared memory, global memory).
   Efficient data movement between these memory levels is crucial.

### 6. Use Cases:

CPU TEE:
   Secure execution of sensitive applications (e.g., encryption, authentication).
   Protecting secrets (keys, passwords) within enclaves.
GPU TEE:
   Confidential machine learning (ML) model inference.
   Secure AI workloads.
   Privacy-preserving computations including zero knowledge proof (ZKP) cryptography computation.

FIG. 3 is a schematic depiction of the scheme for Managing Multiple TEE Instances of blockchain Node, Sequencer and Prover. This illustrates the horizontal scaling capability of the system. Multiple blockchain Nodes, Sequencers and Provers can set up trust between them in a “TEE Mesh” by handshaking and key sharing and thus multiple attestations are made to achieve sequencer consensus and prover workload distribution.

In order to provide horizontal scaling and resilience, the TEE ZK Rollup scheme supports multiple TEE instances (TEE “Mesh”). A consistent and persistent secret key is required so that data encrypted and sealed by one TEE can be decrypted and unsealed by another.

Fingerprints of the code are stored immutably in the global state of the External Blockchain smart contract when it is created. In this mode, the TEE is treated as an extension of the smart contract.

### ZK Rollup Mesh TEE Provisioning:

In this model there are many copies of the same TEE enclave and each enclave can communicate with any of the other enclaves in the network. The process for key provisioning is:
1. The first enclave in the network is started and generates a random private key, the address of the enclave server is stored.
2. Another enclave is started, and both enclaves it request the relevant section of the list of other enclave server's code fingerprints (from a External Blockchain Smart Contract TEE Registry 500).
3. The second enclave initiates a transport layer handshake with the first enclave. Both server and client send SSL certificates as part of this handshake. Both server and client provide signatures attesting to the public key and code fingerprint in the certificate.
4. Both server and client search for the code fingerprint of their handshake counterparty within the white list of allowed fingerprints received from the External Blockchain.
5. The second enclave then sends its identity to the first enclave. The second enclave responds with a symmetric secret key.
6. The second enclave then uses this secret key to decrypt its state data.
7. Further enclaves then perform steps 2-4 in order to initiate communication with other servers, and optionally steps 5, 6 to unseal and decrypt state. The ‘Mesh’ is this network of mutually attested encrypted communication channels between TEEs.
8. Optionally each enclave can seal the key to its code fingerprint and try to unseal first before requesting a key from another enclave.

This scheme enables trusted sharing of data across a network mesh of enclaves. A secret key is then generated by one, and shared using symmetric encryption keys with the other enclaves, such that each enclave in the trusted network of enclaves now has the same.

When the server responds with a key (step 5), that key must be shared with all other provisioning servers. This can be achieved by direct communication using the same secure channel setup described in steps 2 to 4. Alternatively, a master key can be shared between provisioning servers, and then subsequent keys can be derived from the client role. Any provisioning server with access to this master key can perform the same provisioning key derivation without communicating with other servers. The provisioning key is a MAC, keyed with the master key, using the client identity and any metadata as the message. The MAC may be used directly as the provisioning key or a KDF may be utilised. Note that for sponge constructions, the implementation is implicit.

### ZK Rollup TEE Code Upgrade

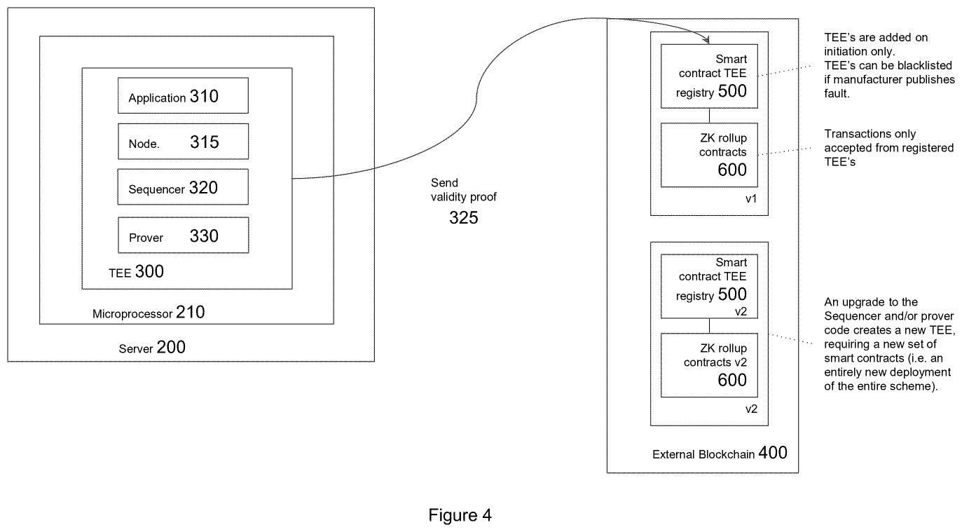

FIG. 4 is a schematic depiction of TEE Code Version and Upgrade Management. TEE's are added on initiation only and the TEE's can be blacklisted if the manufacturer publishes a fault. Transactions are only accepted from registered TEE's, which are version 1 ‘v1’. An upgrade to the ZK Rollup components including the blockchain Node, Sequencer or Prover code creates a new TEE, and therefore version 2, requiring a new set of smart contracts (i.e. an entirely new deployment of the entire scheme v2).

Modifying the enclave code will change its code fingerprint, which has been immutably stored in a smart contract. By design, internal services within the mesh will then block communications with that enclave. Therefore in order to update code, we must update the list of fingerprints stored in the smart contract. When an update is performed we get a new code fingerprint value for the new version. For security reasons we do not want our current enclaves to blindly share with a new TEE In order to share persistent secret keys, and communicate via the attestation-enhanced transport layer protocol with future updates of the enclave code, an enclave registry contract is maintained. This contains a list of all accepted code fingerprints. When a new version of the code is released, the new code fingerprint will be submitted to the registry using hardware with a pre-registered multisig address. A fixed number of blocks must pass before the new value is accepted in the registry. The delay will be long enough to give users time to audit and verify the updated code. If any issues are identified code fingerprint, updates would be stopped, any issues fixed, and the process would be restarted.

Values can also be revoked from the list using the hardware multisig in the case where security vulnerabilities are identified, in this case there is no time delay.

Once the time delay has passed the new code fingerprint value will be included in the allowed list. The existing enclaves can query the registry via a number of public block explorers and/or a set of verifiable or decentralized blockchain listeners, to get the MRENCLAVE (or equivalent) values that it is allowed to share persistent keys with.

The full history of the registry contract is publicly available on the External Blockchain and widely distributed for audit, such that any malicious code tied to a malicious code fingerprint, will be available externally creating reputational damage for the malicious party.

### ZK Rollup TEE End to End Process

The method for carrying out the ZK Rollup transaction process is through a TEE ZK Roll Up configuration.
A typical ZK Roll Up solution (also known as a type of “layer 2, “layer 3”, “AppChain”) involves:
   An Application creates a transaction for a user to sign (optional step, the user may also originate the transaction in their wallet).
   A User with a private key 112 (also known as a Wallet) signs the transaction.
   The transaction is sent to a blockchain Node, which interacts with a Sequencer 212.
   The blockchain Node and Sequencer build up an ordered batch of such transactions and then send the batch to a Prover or proof aggregator 330, and the batch's hash, signed, to the External Blockchain
   The Prover 330 generates a zero knowledge “Validity Proof” that would allow a verifier 410 to verify the integrity of the transactions in the batch (for example that accounts have only spent balances that they already had, and that there is no double spending in the system).
   The Validity Proof reveals nothing about the underlying batch of transactions except that the prover has knowledge of a valid batch with the signed batch hash, but enables their integrity to be verified. The invention may optionally provide knowledge of valid Validity Proof s instead.
   The Validity Proof is sent to a smart contract on an External Blockchain (e.g. “layer 1” blockchain, such as Ethereum, where it is verified, to ensure integrity of the ZK rollup batch of transactions, and stored.

### Lack of Data Privacy in a ZK Rollup System:

In a typical ZK rollup (“layer 2”, “layer 3”, “AppChain”) system all of the data is visible to all of the participants, as such, the Operator of the blockchain Node, Prover and Sequencer can see all of the transactions.
If the transactions are of a sensitive nature (e.g. they contain private data such as account balances, transactions, account identity, including orders/transactions that could be front-run by the party operating the blockchain Node, Prover or Sequencer, whether in the blockchain database or blockchain logs), then it would be preferable for the blockchain Node, Prover and Sequencer to be designed such that this information is hidden from the Operator(s). This invention provides this property.
If the blockchain Node, Prover and Sequencer are operated in a privacy-preserving environment, such that Operators do not have direct access to the data/transactions being processed or at rest, then it would then be useful to provide proof/evidence to users of the system that the privacy-preserving environment where their transactions are processed is indeed performing the processing they expect AND is not exposing the sensitive data to the blockchain Node, Prover or Sequencer Operator(s). This invention provides this property.

A core aspect of the present invention is a system and method that enables ZK rollup systems to be hosted seamlessly in a Trusted Execution Environment (TEE's, aka hardware secure enclaves 211) such that the Operator(s) can have no access to the user data or the transactions, yet the users of the system have all of the cryptographic guarantees and programmable access to data and transactions in order to fully benefit from the system.
The invention enables users, that is blockchain wallet holders, to send transactions to ZK rollup components that are hosted inside a TEE “mesh”, and retrieve the state of their own account (transactions and smart contracts in which they participate, and assets “owned” by them).
   Where Account Abstraction is used (a feature of modern blockchains where the user wallet 111 is delegated to a smart contract 410), the abstracted account of the user will be referenced as the account creating the transactions that may be retrieved and viewed.
   Users will be able to take this state that they have retrieved from the TEE and validate it using the Validity Proof s posted to the blockchain, as well as TEE signatures.
The invention allows role-based access rules to information stored in the blockchain to be defined programmatically in smart contracts. Smart contracts do not ordinarily provide this property. This is specific or unique to the invention.
The invention allows a single entry point into the TEE including a modified blockchain RPC/API that only permits data to be retrieved by an account that has pre-defined access to that information. The invention blocks all other access to information held inside the TEE.
The invention ensures that users only receive information that is shared with them in accordance with the rules defined in the blockchain smart contracts, and proof that the ZK rollup mesh that processed the transaction from receipt through to generating the Validity Proof ran in a privacy-preserving TEE.
The invention allows an encrypted version of the ZK rollup state to be safely distributed and stored elsewhere, such that each user (i.e. wallet account owner) could decrypt the data that they are permissioned to access, and not depend on the blockchain Node, Sequencer or Prover Operator in order to access their own data.
In this invention, any transactions containing sensitive data (e.g. identity information, amounts, balances) are hidden from the blockchain Node, Prover and Sequencer Operators.
In this invention, any orders sent, signed and encrypted by a user to the ZK rollup running inside the TEE will not be visible to the Application, blockchain Node, Prover or Sequencer Operators, thereby preventing front-running.
The invention includes a privacy-enabled blockchain explorer component where a user wallet 111 holder can view the state of their transactions and smart contract data shared with their account (example of a standard, non-privacy-preserving ZK rollup explorer (zksync): https://explorer.zksync.io).

In a standard ZK rollup system, an operator of the system can see all of the data sent by users.

In this invention it is emphasized that data sent to the ZK rollup components (blockchain Node, Sequencer and Prover) will be encrypted and processed in a privacy-preserving environment TEE “mesh”.

The following table lists an example of data sent to a ZK rollup blockchain Node, Sequencer and Prover, and describes who will be able to access and see this data.

| | Data item | Who can see? |
|---|---|---|
| Transaction | Transaction ID | All |
| | From | Sender, Receiver |
| | To | Sender, Receiver |
| | Transaction Hashes | All |
| | Transaction Amount | Sender, Receiver |
| | Transaction Unit | Sender, Receiver |
| | Contract Address | Sender, Receiver |
| | Input Data | Sender, Receiver |
| | Fee Amount | All |
| | Status | All |
| | Timestamp | All |
| Block | Number | All |
| | Block Hash | All |
| | Timestamp | All |
| | Status | All |
| | Root Hash | All |
| Smart Contract | Smart Contract Code | All |
| | State | As defined in the smart |
| | | contract code |
| Network Stats | Number of Committed | All |
| | Blocks | |
| | Number of Verified Blocks | All |
| | Number of Transactions | All |

The invention involves hosting each of the components (Application Server, blockchain Node, Prover, Sequencer) in one or more inter connected TEE (trusted execution environments, or equivalently hardware secure enclaves).

A II of these components could be deployed into the same TEE or split across multiple TEE's, and the TEE's could be multiple cores on the same server, or split across multiple servers or virtual machines.

### Initiation Phase Flow of the Present Invention:

1. All required TEE's in the system (Application, blockchain Node, Sequencer, Prover) are “initiated” with the required source code and libraries, and a processor manufacturer attestation is requested and stored in order to baseline each TEE. This “Attestation” is available later for users of the system to inspect and verify independently.
2. All Application TEE's perform transport layer handshakes in order to enable them to exchange symmetric keys, used for encrypted and decrypting data, to create redundancy across multiple Application TEE's, in case a TEE processor should fail, or be declared vulnerable by the manufacturer.
3. All blockchain Node TEE's exchange public keys in order to create redundancy across multiple blockchain Node TEE's.
4. All Sequencer TEE's obtain secret keys from provisioner TEEs to create redundancy across multiple Sequencer TEEs.
5. All Prover TEE's obtain secret keys from provisioner TEEs to create redundancy across multiple Prover TEEs.
6. A “Registry” smart contract is created on an External blockchain, listing the public keys and fingerprints of each TEE in the system.

### a Typical Transaction Flow of the Present Invention:

1. The user uses the application via a browser 113 on their device, or the application runs on a backend server inside an organization.
2. A transaction is created by a Browser 113 Application, Mobile Application, or an Internal Application.
3. The user signs and (optionally) encrypts the transaction 800 using their wallet on their device (or an additional key created for encryption purposes, if their blockchain private key 112 and wallet do not support encryption) using the public key of the target TEE (either Application Server or Sequencer, see below), or the transaction is sent encrypted to the TEE using TLS or another transport layer protocol.
4. The encrypted transaction is sent to the blockchain Node in a TEE, which communicates with the Sequencer in the TEE mesh.
5. The blockchain Node receives the transaction over the encrypted and attested channel;
6. The blockchain Node checks the validity of the transaction and rejects it if it is not valid.
7. The blockchain Node communicates with a Sequencer then places the transaction in the correct order relative to other transactions.
   a. If the Sequencer is part of a “decentralized” network of Sequencers, then the Sequencer receives transactions from other Sequencers and optionally proposes a batch, and interacts with the other Sequencers to reach consensus before sharing the consensus batch with the smart contract
   b. Running this process inside a TEE ensures that the operator cannot see incoming transactions, and cannot influence their order (e.g. by inserting their own order ahead of that of another user, an activity known as front-running).
8. The blockchain Node or Sequencer may encrypt each transaction and related state in the ordered list (including ordering information), using the public keys of the transaction owner(s) and smart contract participants, so that they may decrypt it in the future.
   a. User-encrypted transactions are distributed in one or more data stores that are directly accessible to users, to enable users to retrieve their transactions in the future independently of the ZK rollup components and operators.
9. The blockchain Node or Sequencer encrypts its state using a TEE key (“sealing”) and stores this in one or more data stores. Additionally the state may be stored using a key scheme that would allow only the complete group of users to decrypt the state with a combination of all of their keys in the case of a catastrophic failure and unavailability of the TEE mesh.
10. The blockchain Node or Sequencer encrypts the ordered list of transactions (optionally forming a “block”) and encrypts those using the secret key from the Provisioner TEE.
11. The blockchain Node or Sequencer TEE signs Merkle tree root hash of the ordered list (or block) of transactions and sends the to the Prover TEE and the signed root to the External Blockchain.
12. The Prover TEE checks the registry smart contract(s) to ensure that the transaction (or block of transactions) came from a valid TEE.
13. The Prover TEE (optionally) decrypts the ordered transactions generating a Validity Proof, which is then output from the TEE and sent to an External blockchain for verification in a smart contract.
   a. The Validity Proof sent to the blockchain is not encrypted, as it does not reveal the underlying transactions.
   b. The Validity Proof sent to the blockchain is signed by the Prover TEE, to provide proof of the source code that was used in order to generate the TEE, and to provide proof that this was executed in a privacy-preserving TEE environment.
      i. The blockchain ZK rollup verifier smart contract in the External blockchain will verify:
         1. That the transaction providing the Validity Proof was sent by a registered and valid (whitelisted and not blacklisted) TEE;
         2. That the Validity Proof is valid.
   c. The Merkle tree of the ZK rollup batch is constructed, such that the Merkle root is signed by the sequencer TEE. The Merkle root validates its child nodes, and their child nodes, up to the leaf nodes, which are themselves, transaction hashes. The prover generates a proof that they have knowledge of valid transactions which produce the given Merkle root (or knowledge of a proof thereof). This proves to a user seeing a Merkle root, but not having access to the data behind the Merkle tree, that the updated hashes were generated correctly, irrespective of whether the prover inside the TEE is running the expected logic.
      i. The Merkle root of the ZK rollup is revealed by the TEE to all users, with proof that each of the hashes in the Merkle tree was generated correctly (i.e. was output from the TEE running the pre-attested code), such that a user can trust that an update to the Merkle tree is valid, even though they can't see the underlying transactions and state for transactions that were not shares with them.
      ii. The RPC interface TEE will allow the user to receive a decrypted copy of their state from their transactions even though they will not have access to all of the other states.

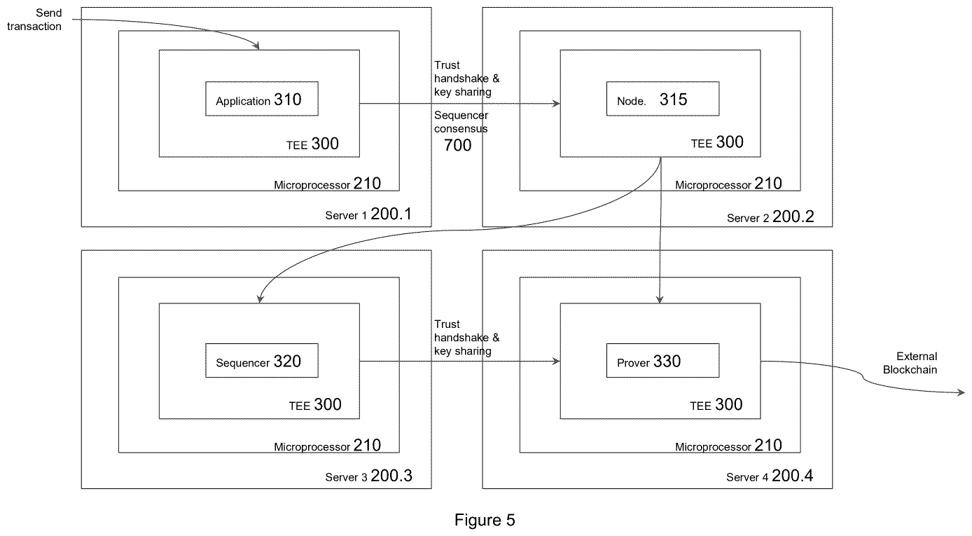

FIG. 5. A schematic depiction of a scheme for obtaining runtime code attestation guarantees from a mesh of TEEs where only some support runtime code attestation

A TEE 300 which supports runtime code attestation (RCA) is given a workload to deploy to a TEE on a microprocessor or GPU 700 which does not support runtime code attestation 800. The TEE with RCA support 300 performs a handshake to verify that the enclave without RCA 800 has followed a secure boot process and is configured correctly.

When the TEE with RCA support 300 is satisfied that it is speaking with a secure TEE 800 it deploys a workload to the TEE 800. By verifying the remote attestation report from the TEE with RCA support 300 a user can be validating the code running inside the TEE without RCA support 800.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1.-40. (canceled)

41. A method for providing a privacy-preserving blockchain scaling solution, the method comprising:
a. hosting Zero-Knowledge (ZK) rollup components within one or more Trusted Execution Environments (TEEs), the ZK rollup components comprising at least a sequencer and a prover;
b. receiving, by the ZK rollup components within the one or more TEEs, a plurality of user transactions destined for a layer-2 network;
c. ordering, by the sequencer within a TEE, the plurality of user transactions into a transaction batch;
d. generating, by the prover within a TEE, a single cryptographic validity proof for the entire transaction batch, wherein the validity proof attests to the integrity of all transactions within the batch without revealing underlying user data; and
e. transmitting the generated validity proof from the one or more TEEs for posting to a smart contract on an external, layer-1 blockchain for verification, thereby securing the layer-2 network while isolating operator access to user data within the TEEs.

42. The method of claim 41, wherein the one or more TEEs are hosted in a Hardware Secure Enclave in a CPU, GPU, or any combination thereof.

43. The method of claim 41, wherein the ZK rollup components are hosted across a plurality of TEEs forming a TEE Mesh, and wherein communication between TEEs in the TEE Mesh is secured via a transport layer handshake that includes a mutual TEE attestation of a code fingerprint of each communicating TEE.

44. The method of claim 43, further comprising creating at least one registry smart contract on the external, layer-1 blockchain, the registry smart contract listing public keys and code fingerprints for each authorized TEE in the TEE Mesh.

45. The method of claim 44, further comprising a step of the prover TEE checking the registry smart contract to ensure a received transaction batch originated from a valid sequencer TEE within the TEE Mesh.

46. The method of claim 41, further comprising sending the validity proof signed by the prover TEE, the signature providing verifiable proof that the validity proof was generated within a TEE running specific, attested source code.

47. The method of claim 41, further comprising encrypting, by the sequencer within the TEE, its state using a TEE-specific key to create a sealed state, and storing the sealed state in one or more data stores to enable recovery.

48. The method of claim 41, further comprising steps of:
a. constructing a Merkle tree of the transaction batch, wherein a root of the Merkle tree is signed by the sequencer TEE; and
b. providing the signed Merkle root to the external, layer-1 blockchain.

49. The method of claim 41, further comprising enabling a blockchain wallet holder to retrieve their specific transaction data from the TEE Mesh based on rules defined in a smart contract, wherein a request for the data is blocked unless a valid account signature is provided with the request.

50. The method of claim 41, wherein hosting the ZK rollup components obviates the need for creating an additional, separate blockchain network with an independent consensus mechanism.

51. A system for providing a privacy-preserving blockchain scaling solution, the system comprising:
a. one or more processors;
b. one or more Trusted Execution Environments (TEEs) operable on the one or more processors; and
c. a non-transitory computer-readable medium storing instructions that, when executed by the one or more processors, cause the system to host Zero-Knowledge (ZK) rollup components within the one or more TEEs, the ZK rollup components configured to:
i. receive a plurality of user transactions destined for a layer-2 network;
ii. as a sequencer component, order the plurality of user transactions into a transaction batch inside a TEE;
iii. as a prover component, generate a single cryptographic validity proof for the entire transaction batch inside a TEE, wherein the validity proof attests to the integrity of all transactions within the batch while maintaining privacy of underlying user data; and
iv. transmit the generated validity proof from the one or more TEEs for posting to a smart contract on an external, layer-1 blockchain for verification.

52. The system of claim 51, wherein the one or more TEEs comprise a Hardware Secure Enclave.

53. The system of claim 51, wherein the ZK rollup components are hosted across a plurality of TEEs forming a TEE Mesh, the TEE Mesh configured to establish secure, mutually attested communication channels between the plurality of TEEs.

54. The system of claim 53, wherein the system is configured to interact with a registry of trusted enclaves held in a smart contract on the external, layer-1 blockchain, said registry listing authorized code fingerprints for enclaves within the TEE Mesh.

55. The system of claim 54, wherein the ZK rollup components are further configured to encrypt their state before storing it, using an encryption key protected by a provisioner TEE.

56. The system of claim 55, wherein the provisioner TEE is configured to only share the encryption key with a receiver TEE after the receiver TEE produces an attestation matching a known code fingerprint in the registry.

57. The system of claim 56, wherein a different receiver TEE is configured to retrieve the same encryption key from the provisioner TEE to recover the state stored by a first receiver TEE, thereby providing redundancy.

58. The system of claim 54, wherein the system allows an operator to upgrade code in the TEEs, and wherein the registry smart contract is configured to enforce that all code updates are made public in the registry before a TEE running the updated code is granted access to existing encrypted state.

59. The system of claim 58, wherein the registry smart contract is configured with a grace period, wherein the grace period enforces a time delay before accepting a new enclave's code fingerprint, thereby causing provisioner TEEs to withhold sharing keys with the new enclave until the grace period has passed.

60. The system of claim 51, wherein the prover component is further configured to sign the validity proof with a key private to the TEE, thereby providing a verifiable attestation of the proof's origin from within a privacy-preserving TEE environment.
